(19) United States
(12) Patent Application Publication
(10) Pub. No.: US 2005/0121087 A1
(43) Pub. Date: Jun. 9, 2005

(54) Three-way valve

(76) Inventor: Tien-Shou Tsai, Chingshui Town (TW)

Correspondence Address: SHIE YU MACHINE PARTS IND CO., LTD., P.O. BOX 2-10, TAINAN CITY, TW

(21) Appl. No.: 10/735,202

(22) Filed: Dec. 9, 2003

(51) Int. Cl. F16K 11/087

(52) U.S. Cl. 137/625.46

(57) ABSTRACT

A three-way valve includes a body, a chamber formed in the body, a valve positioned in the chamber and having a shaft formed to extend upward from the valve and connected with a lateral grip at an outside of the body. The grip is rotated to open and close easily the three-way valve. The valve is placed in advance in a mold in which the body is to be formed, and positioned in the chamber after the body is formed by injecting process. O-shaped rings used in conventional three-way valves are not necessary.

### FIELD OF THE INVENTION

This invention relates to a three-way valve, particularly to one having a high pressure-enduring force and preventing leakage sufficiently.

### BACKGROUND OF THE INVENTION

A first conventional three-way valve shown in FIG. 1 includes a body 10 formed integral, a chamber 100 formed in the body 10, and two O-shaped rings 101, 102 located in the chamber 100 matching to a valve 11 so as to have highly effective function of leakage prevention during it is closed up.

The valve 11 is shaped spherical, having a lateral through hole 110 possible to be aligned with two outlets 1013, 104 to become open for liquid to flow out.

Next, a shaft 12 is provided to connect with an upper end of the valve 11, and a grip 13 is laterally connected with an upper end of the shaft 12 so that rotation of the grip 13 may effect opening and closing of the three-way valve.

After the valve 11 is assembled in the chamber 110, a sleeve 14 is provided to combine with one side of the body 10, which is further provided with male threads 105 to engage with male threads 140 of the sleeve 14, preventing leaking from the engaging position of the sleeve 14 combined with the body 10 by means of an O-shaped ring 141 fitting around an inner end of the sleeve 14. However, the engagement of the male threads 140 and the female threads 105 may cause incomplete tight closeness for the three-way valve. Further, in injecting forming process of the body 10 and the sleeve 14, the female threads 105 and the male threads 140 may liable to extend outward so that the engaging portion of the sleeve 14 with the body 10 may easily cause leakage, even through the O-shaped ring should be used. Further the error of the male threads 141 and the female threads 105 may also give rise to large friction between the O-shaped ring 101 and the valve 11, so the valve 11 may be too tight to rotate to cause uneasiness in opening and closing. Or a large force is necessary to open and close the three-way valve.

A second conventional three-way valve shown in FIG. 2 has almost the same structure except that the valve is only a quarter of a sphere instead of the complete sphere of the valve 11 in the first conventional one. Then the second three-way valve has the same male threads 21 in the body 20, and the sleeve 22 also has female threads to engage with the male threads 21. Therefore the second conventional three-way valve also has the same disadvantage as the first conventional one.

### SUMMARY OF THE INVENTION

This invention has been devised to offer a three-way valve having a more simple structure than the conventional ones described above, smooth in closing and opening, and preventive for leakage.

The feature of the invention is a valve and shaft assembled with each other in advance, and then the assembled unit is placed in a mold used for forming a body and positioned in a chamber of the body after the body is formed by injecting forming process. So the three-way valve in the invention has a simpler structure than the conventional ones described above, and possible to prevent leakage sufficiently.

### BRIEF DESCRIPTION OF DRAWINGS

This invention will be better understood by referring to the accompanying drawings, wherein:

FIG. 1 is a cross-sectional view of a first conventional three-way valve;

FIG. 2 is a perspective view of a second conventional three-way valve;

FIG. 3 is a side view of a first embodiment of a three-way valve in the present invention;

FIG. 4 is a cross-sectional view of the line A-A in FIG. 3;

FIG. 5 is a perspective view of a second embodiment of a three-way valve in the present invention;

FIG. 6 is an upper view of the second embodiment of a three-way valve in the present invention; and,

FIG. 7 is a cross-sectional view of the second embodiment of a three-way valve in the present invention.

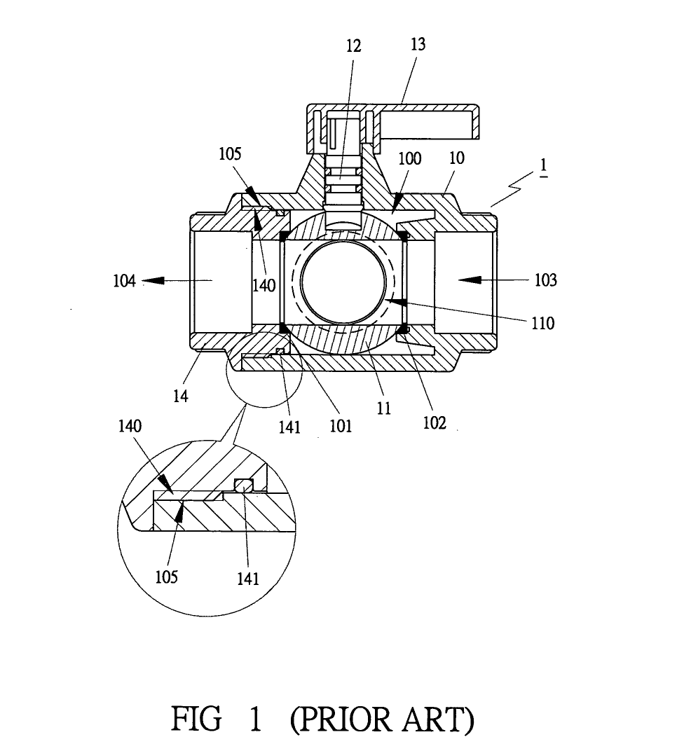

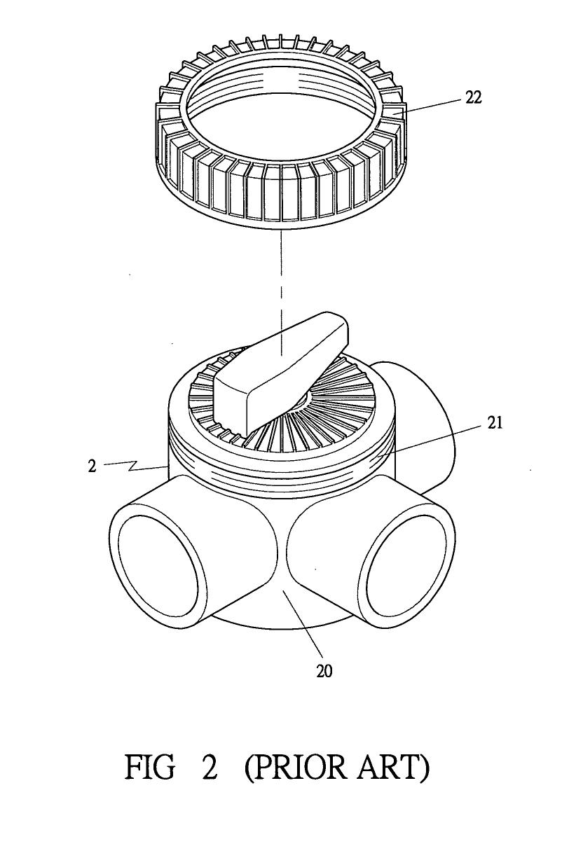

### DETAILED DESCRIPTION OF THE INVENTION

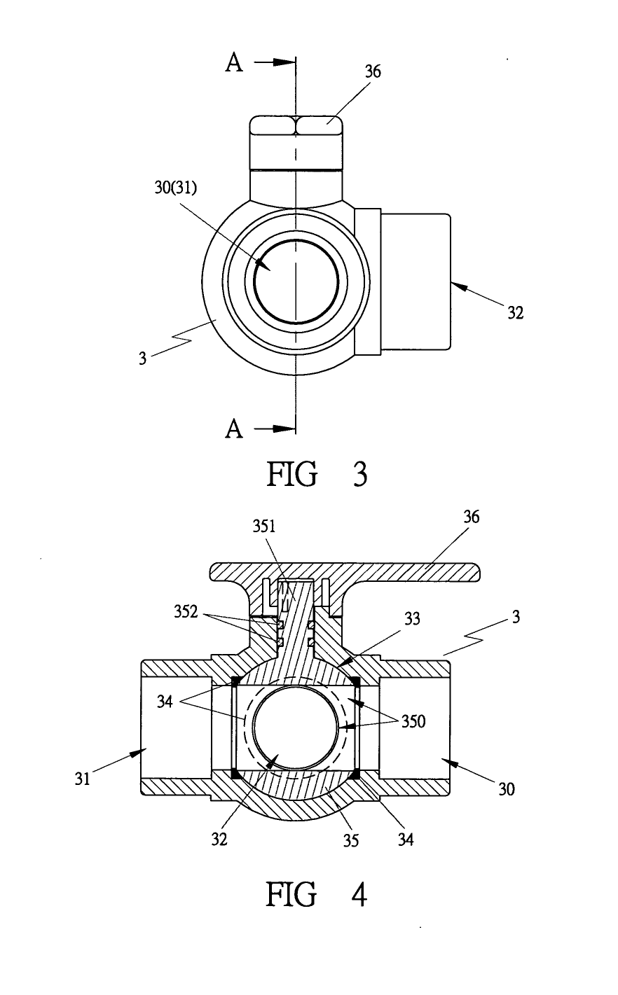

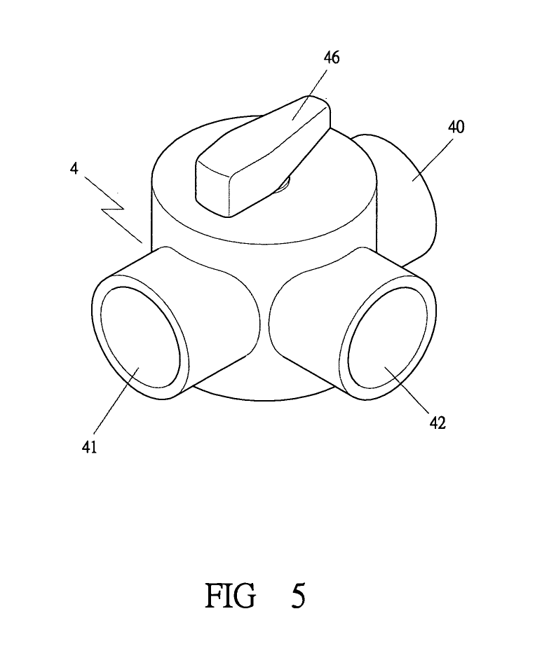

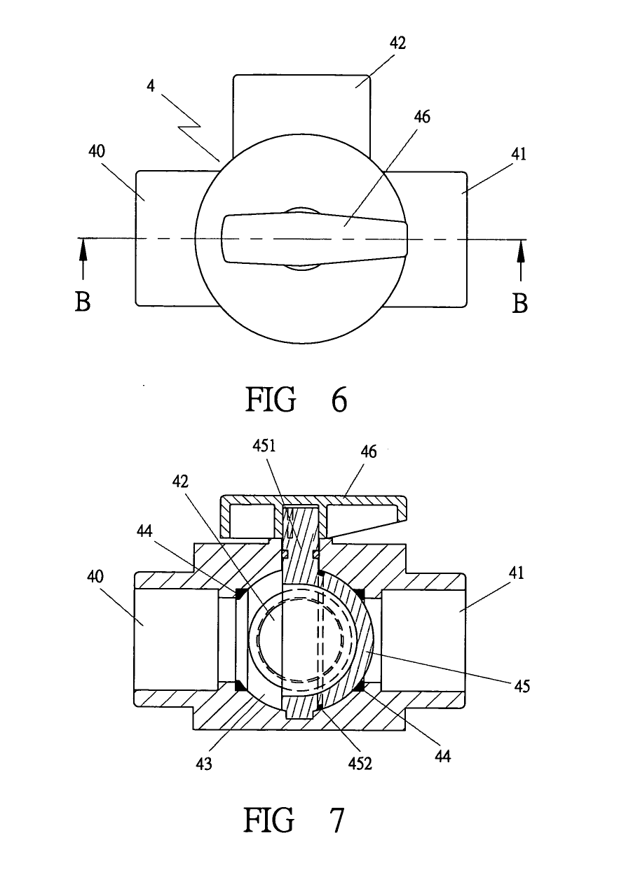

A first preferred embodiment of a three-way valve in the present invention, as shown in FIGS. 3 and 4, includes a body 3, three passageways 30, 31, 32 formed integral in the body 3, a chamber 33 formed integral in the body 3, a plurality of O-shaped rings 34 fixed in the chamber 34 and respectively facing the three passageways 30, 31, 32, and a valve 35 to close completely the three passageways 30, 31, 32 with coordination of the three O-shaped rings 34.

The valve 35 is positioned in the chamber 33, having a spherical shape and a plurality of through holes 350 for flowing of liquid through any of the three passageways 30, 31, 32, and a shaft 351 formed integral with the valve 35, and a plurality of O-shaped rings 3 fitting around the shaft 351 with spaced-apart distance for preventing liquid from leaking the gap between the shaft 351 and a shaft hole of the body 10. Further, a grip 36 is provided at an outside of the body to combine laterally with an upper end of the shaft 351 so the grip 36 can rotate the valve 35 to open or close the passageways 30, 31, 32.

Next, before forming the body 10 by injecting process, the valve 35 is to be placed in advance in a mold used for forming the body 10 so that the valve 35 may be positioned in the chamber 33 after the body 10 has been formed, simplifying the manufacturing process of the three-way valve in the invention. In addition, the pressure-enduring property is also upgraded for the three-way valve.

A merit of the invention is that the valve is formed to position in the body at the same time in injecting forming the body, simplifying the manufacturing process for the three-way valve, and upgrading pressure-enduring characteristic and leak-prevention function and convenient handling as well.

While the preferred embodiments of the invention have been described above, it will be recognized and understood that various modifications may be made therein and the appended claims are intended to cover all such modifications that may fall within the spirit and scope of the invention.

1. A three-way valve comprising:
a body provided with a plurality of passageways for liquid to flow in and out, a chamber in an intermediate portion, and a plurality of O-shaped rings attached in said chamber and respectively facing said holes:
a valve of a spherical shape positioned in said chamber, having a plurality of through holes possible to be aligned respectively with said passageways of said body, a shaft formed integral with said valve and extending upward from an upper end of said valve, a plurality of O-shaped rings fitting around said shaft, an upper end passing through said body and connected with a lateral grip: and,
said valve placed in advance in a mold in which said body is to be formed by an injecting process, said valve positioned in said chamber of body after said body is formed in the mold, said grip rotated to rotate said valve to open and close said passageways of said body.
